(19) United States
(12) Patent Application Publication
(10) Pub. No.: US 2008/0240006 A1
(43) Pub. Date: Oct. 2, 2008

(54) MOBILE COMMUNICATION DEVICE AND POWER CONSERVATION METHOD THEREOF

(75) Inventors: Yu-Hung Tseng, Taipei (TW); Kuang-Ting Cheng, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/053,618

(22) Filed: Mar. 23, 2008

(30) Foreign Application Priority Data
Mar. 27, 2007 (TW) 96110487

(51) Int. Cl. H04B 7/00

(52) U.S. Cl. 370/310

(57) ABSTRACT

A mobile communication device and a power saving method thereof are provided. The method determines whether to enter a normal mode or a power saving mode according to the moving state of the mobile communication device to achieve the objective of saving power. The timing start function of the mobile communication device is started under the normal mode, and then the mobile communication device starts every a predetermined time to determine whether to switch to a cell according to the signal intensity of cells. The timing start function of the mobile communication device is closed under the power saving mode. If the device is not moved for a long predetermined time under the power saving mode, it returns to the normal mode from the power saving mode.

### CROSS-REFERENCE TO RELATED APPLICATION

This application claims the priority benefit of Taiwan application serial no. 96110487, filed on Mar. 27, 2007. The entirety the above-mentioned patent application is hereby incorporated by reference herein and made a part of specification.

### BACKGROUND OF THE INVENTION

1. Field of the Invention

The invention relates to a communication device and a power saving method thereof and, more particularly, to a mobile communication device and a power saving method thereof.

2. Description of the Related Art

Since the step of the modern society is accelerated and timeliness is stressed in the communication mode, a mobile communication device such as a mobile phone has been one of needful important communication tools because of its portability and convenience.

Along with the progress of the science and technology, functions of the mobile phone become further diverse, but the power consumption of the mobile phone is also increased simultaneously. For example, to ensure that the mobile phone maintains preferred communication signal intensity during the moving state, the method of the conventional technology is to make the mobile phone detect the signal intensity of the present selected servicing cell and neighboring cells at set intervals (5 seconds˜30 seconds) to determine whether to switch the cell when the mobile phone is in standby periods. Although the above method solves the problem of the communication signal intensity, the power consumed by the mobile phone in the process of detecting the signal intensity every time is more than ten times as much as the power consumption during standby periods.

In the conventional technology, although the mobile phone is not in a moving state, the mobile phone still detects the signal intensity of the present selected servicing cell and the neighboring cells at set intervals, which consumes a great deal of electric power. Especially, when a user is sleeping at home, the mobile phone is not in the moving state, and then it is unnecessary to continuously repeatedly detect the signal intensity of the present selected cell and the neighboring cells at this time. If the number of the times of detecting the signal intensity is appropriately decreased, the power consumption of the mobile phone can be decreased, which is helpful to prolong the standby time of the mobile phone. And then the user does not often need to replace the battery of the mobile phone or charge up the mobile phone, and great convenience is brought to the user.

### BRIEF SUMMARY OF THE INVENTION

The invention provides a power saving method of a mobile communication device, and in the method, whether to enter a normal mode or a power saving mode is determined according to the moving state of the mobile communication device to achieve the objective of saving power.

The invention further provides a mobile communication device, and a timing start function is started or closed by sensing the moving state of the mobile communication device to decrease power consumption.

The invention further provides a mobile communication device, and a timing start function is started or closed by sensing the moving state of the mobile communication device to avoid additional electricity loss.

The invention provides a power saving method of a mobile communication device, and the method includes the following steps of entering a normal mode, starting a timing start function of the mobile communication device to make the mobile communication device determine whether to switch to a selected cell every a first predetermined time according to the signal intensity of a plurality of cells when the normal mode is entered, and closing the timing start function when a power saving mode is entered according to the moving state of the mobile communication device.

In the above power saving method of the mobile communication device, wherein the step of entering the power saving mode according to the moving state of the mobile communication device is done after the mobile communication device is not moved for a second predetermined time. In addition, the power saving method of the mobile communication device further includes the following steps of entering the normal mode if the mobile communication device is moved under the power saving mode. In addition, the mobile communication device returns to the normal mode after the power saving mode has been entered for a third predetermined time.

The invention provides a mobile communication device which includes a sensor for detecting a moving state of the mobile communication device and a communication circuit coupled to the sensor, wherein a timing start function is started when a normal mode is entered, and the timing start function makes the communication circuit determine whether to switch to a selected cell every a first predetermined time according to signal intensity of a plurality of cells, and the communication circuit is capable of entering a power saving mode according to the moving state and closing the timing start function.

The invention provides a mobile communication device which includes a communication circuit for performing the communication function of the mobile communication device, a sensor which is coupled to the communication circuit and is used for detecting a moving state of the mobile communication device, and a control circuit coupled to the communication circuit and the sensor, wherein a timing start function is started when a normal mode is entered, and the timing start function makes the communication circuit determine whether to switch to a selected cell every a first predetermined time according to signal intensity of a plurality of cells, and when the control circuit enters a power saving mode according to the moving state, the timing start function is closed.

To sum up, the invention determines to enter a normal mode or a power saving mode according to the moving state of a mobile communication device to achieve the objective of saving power. The timing start function of the mobile communication device is started under the normal mode, and then the mobile communication device starts every a first predetermined time to determine whether to switch the cell according to signal intensity of cells. The timing start function is closed under the power saving mode. Electricity loss of the timing start function is avoided under the power saving mode, and if the mobile communication device is moved, the mobile communication device enters the normal mode, so that the ability of determining whether to switch the cell is not hindered.

The preferred embodiment of the invention at least has the following advantages.

First, a mobile communication device which is being moved can maintain preferred signal intensity by determining whether to switch the cell according to the signal intensity of the present selected cell and neighboring cells every a predetermined time.

Second, under a normal mode, whether a power saving mode is entered is determined according to whether the mobile communication device is moved during a second preset time, and then the additional electricity loss which occurs for the mobile communication device 10 repeatedly switches between the power saving mode and the normal mode in a short time is avoided.

Third, the operation of unnecessary components is closed under the power saving mode, for example, detecting the signal intensity of the present selected cell and the neighboring cells every the first predetermined time is not done, so that power consumption is greatly decreased and the standby time of the mobile communication device is increased.

Fourth, once the mobile communication device is moved under the power saving mode, the mobile communication device returns to the normal mode to detect the signal intensity of the present selected cell and the neighboring cells to maintain preferred signal quality.

Fifth, after a timer measures for a third predetermined time under the power saving mode, the mobile communication device is capable of returning to the normal mode to avoid the bad signal quality caused by a special condition that the signal intensity of the present selected cell is lower than the signal intensity of the neighboring cell.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a structural diagram showing a mobile communication device according to the preferred embodiment of the invention.

FIG. 2 is a flow chart showing a power saving method of a mobile communication device according to the preferred embodiment of the invention.

FIG. 3A˜FIG. 3D are structural diagrams showing another mobile communication device according to the preferred embodiment of the invention.

### DETAILED DESCRIPTION OF THE EMBODIMENTS

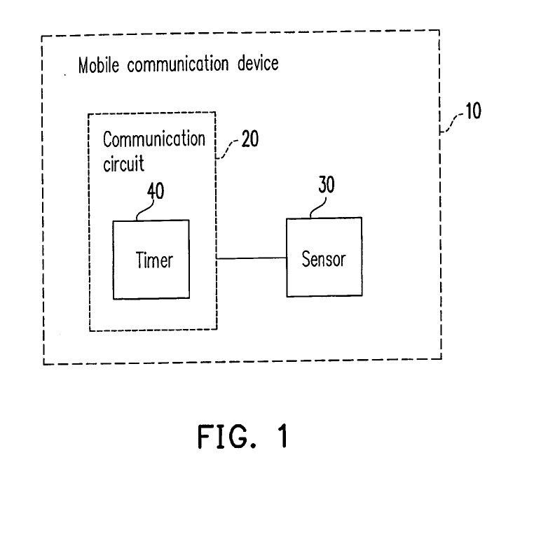

FIG. 1 is a structural diagram showing a mobile communication device according to the preferred embodiment of the invention. Please refer to FIG. 1. In the embodiment, a mobile communication device 10 is, for example, a mobile phone, and persons having ordinary skill in the art can know that the mobile phone in the embodiment only is an example and in other embodiments, the mobile communication device 10 can be an electronic device such as a personal digital assistant (PDA) having a communication function, a watch having a communication function and so on, and therefore, the invention is not limited by the specific embodiment. The mobile communication device 10 includes a communication circuit 20 and a sensor 30. The communication circuit 20 is, for example, a communication chip which is for communication function of the mobile communication device 10, and has a timer 40. The timer 40 sends out a trigger signal every a first predetermined time (ten seconds are taken as an example in the embodiment) to notify the communication circuit 20 to detect the signal intensity of the present selected cell and a plurality of neighboring cells. In addition, the timer 40 can also measure a second predetermined time (five minutes are taken as an example in the embodiment) and a third predetermined time (three hours are taken as an example in the embodiment) to notify the mobile communication device 10 to enter a normal mode or a power saving mode, and generally speaking, the third predetermined time is longer than the first preset time, so that the time of starting a system is prolonged because once the system is started, the consumed electricity is more than the electricity consumed by the system which is under a hibernation state.

Although the embodiment utilizes the timer 40 to measure the time, persons having ordinary skill in the art can replace the timer 40 with other device such as a counter which has a function similar to measure the time according to their requirements and can flexibly adjust the length of the first, second and third predetermined time according to their requirements When the communication circuit 20 finds the signal intensity of one neighboring cell is higher than the signal intensity of the present selected cell, the signal of the present selected cell is replaced with the signal of the neighboring cell. And then when a user moves the mobile communication device 10, the mobile communication device 10 can maintain the signal intensity at the best state at any time.

However, when the user does not move the mobile communication device 10, the action that the communication circuit 20 continuously detects the signal intensity of the present selected cell and the neighboring cells not only is no help for adjusting the signal intensity but also wastes the electricity. Therefore, the timer 40 is controlled to work or not by the sensor 30 detecting whether the mobile communication device 10 is moved, and the objective of saving power is achieved.

The sensor 30 can be a motion sensor, a geomagnetic sensor or both. In the embodiment, the sensor 30 is a geomagnetic sensor which has a function similar to the function of a compass and can determine whether the orientation is changed. In other words, whether the mobile communication device 10 is moved is determined by determining whether the orientation is changed. Persons having ordinary skill in the art can, according to their requirements, replace the geomagnetic sensor of the embodiment with a motion sensor or other device such as a pedometer for running, an energy storage device used by a stem-winder or a gyroscope which can detect the movement of an object. In other words, when the mobile communication device 10 is moved, the sensor 30 can detect whether the mobile communication device 10 is moved in real time. And then, in connection with the sensor 30, the following illustrates how to control the mobile communication device 10 to achieve the objective of saving power under different conditions.

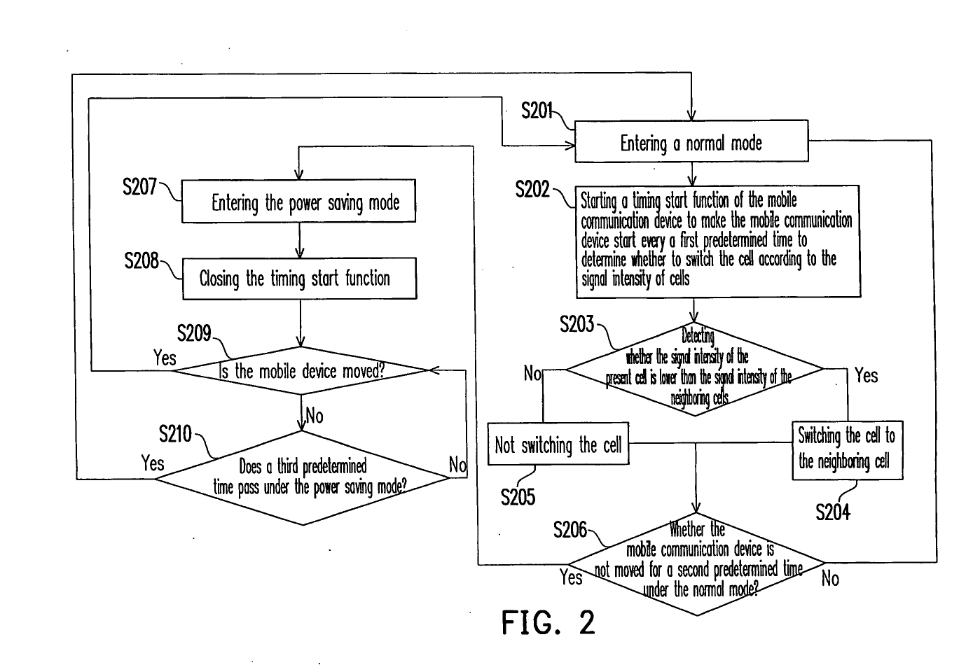

From the above, please refer to FIG. 2 which is a flow chart showing a power saving method of a mobile communication device according to the preferred embodiment of the invention. The uppermost spirit of the embodiment is that the mobile communication device 10 is determined to enter a normal mode or a power saving mode according to the moving state of the mobile communication device 10. When the mobile communication device 10 is not operated, it is in a hibernation state, that is, functions of partial components are closed, for example, the clock is closed to avoid additional electricity loss, and the mobile communication device 10 starts to detect the signal intensity of the cells when an appropriate time (the first predetermined time) arrives, and at this time, more electricity can be consumed and the mobile communication device 10 enters the hibernation state again after finishing detecting the signal intensity of the cells. The electricity which is consumed by the start of the mobile communication device 10 is more than the electricity which is consumed in the hibernation state. The mobile communication device 10 starts every a first predetermined time under the normal mode and starts when the third predetermined time arrives under the power saving mode, and the third predetermined time is longer than the first predetermined time, so that the system can save electricity. If the initial state of the mobile communication device 10 is a normal mode, once the mobile communication device 10 enters the normal mode (step S201), the timing start function of the timer 40 of the mobile communication device 10 is started, and then the mobile communication device 10 starts every a first predetermined time (such as 10 seconds) to determine whether to switch the cell according to the signal intensity of the cells (step S202). Next, the step S203 in which the mobile communication device 10 detects whether the signal intensity of the present selected cell is lower than the signal intensity of a neighboring cell is performed. If the signal intensity of the present selected cell is lower than the signal intensity of the neighboring cell, the cell is switched to the neighboring cell (step S204); on the contrary, if the signal intensity of the present selected cell is higher than the signal intensity of the neighboring cell, the cell is not switched (step S205).

The sensor 30 detects whether the mobile communication device 10 is not moved for a second predetermined time (such as 5 minutes) under the normal mode (step S206). If the mobile communication device 10 is moved during the second predetermined time, the signal intensity of the neighboring cells of the mobile communication device 10 is possible to be higher than the signal intensity of the present selected cell, so that whether the signal intensity of the neighboring cells is higher than the signal intensity of the present selected cell needs to be detected to maintain the preferred signal quality, and then it returns to the step S201; on the contrary, if the mobile communication device 10 is not moved for a second predetermined time, the signal intensity of the neighboring cells of the mobile communication device 10 cannot be higher than the signal intensity of the present selected cell, so that it is unnecessary to continuously detect whether the signal intensity of the neighboring cells is higher than the signal intensity of the present selected cell, and then the mobile communication device 10 enters the power saving mode (step S207). In addition, the advantage of setting the second predetermined time is to avoid the mobile communication device 10 entering the power saving mode when the mobile communication device 10 is placed for a moment, and then the additional electricity loss caused by the mobile communication device 10 repeatedly switching between the power saving mode and the normal mode in a short time is avoided.

From the above, once the mobile communication device 10 enters the power saving mode, the timing start function of the first predetermined time is closed (step S208). That is, when the timing start function of the first predetermined time is closed, the mobile communication device 10 will not detect the signal intensity of the neighboring cells, and then times of starting the system and the operation time of the system are reduced, so that the objective of saving power is achieved. Specifically, the user may sleep at home during the period, and the mobile communication device 10 is placed at the side of the head of the bed. The user may also be working, and the mobile communication device 10 is placed at a table. During the above conditions, the mobile communication device 10 is often not be moved for a long time, and then number of the times of detecting the signal intensity of the cells by the mobile communication device 10 is greatly decreased, so that the objective of saving power is achieved.

The sensor 30 detects whether the mobile communication device 10 is moved under the power saving mode (step S209). If the mobile communication device 10 is moved, the mobile communication device 10 returns to the normal mode (step S201). Because the signal intensity of the neighboring cells is possible to be higher than the signal intensity of the present selected cell when the mobile communication device 10 is being moved, the mobile communication device 10 returns to the normal mode for the signal intensity quality. Persons having ordinary skill in the art can also modify the embodiment according to their requirements, for example, the sensor 30 is used to determine the displacement distance of the mobile communication device 10, and the mobile communication device 10 enters the normal mode when the displacement distance is more than a preset value (step S201), which can avoid the mobile communication device 10 entering the normal mode when the user only takes the mobile communication device 10 to answer a call and the mobile communication device 10 is not moved for a long distance, so that the objective of saving power is better achieved.

In addition, if the mobile communication device 10 is not moved in step S209, the step S210 is entered. Under the power saving mode in step S210, the timer 40 measures whether the third predetermined time (such as 3 hours) passes. The mobile communication device 10 returns to the normal mode (step S201) after the third predetermined time has passed under the power saving mode. If the third predetermined time has not arrived, the method returns to step S209 to continuously detect whether the mobile communication device 10 is moved. The above method can avoid the special condition that the signal intensity of the neighboring cells is higher than the signal intensity of the present selected cell when the mobile communication device 10 is not moved occurring. For example, the fault of the present selected cell causes that the signal intensity of the present selected cell is lower than the signal intensity of the neighboring cells.

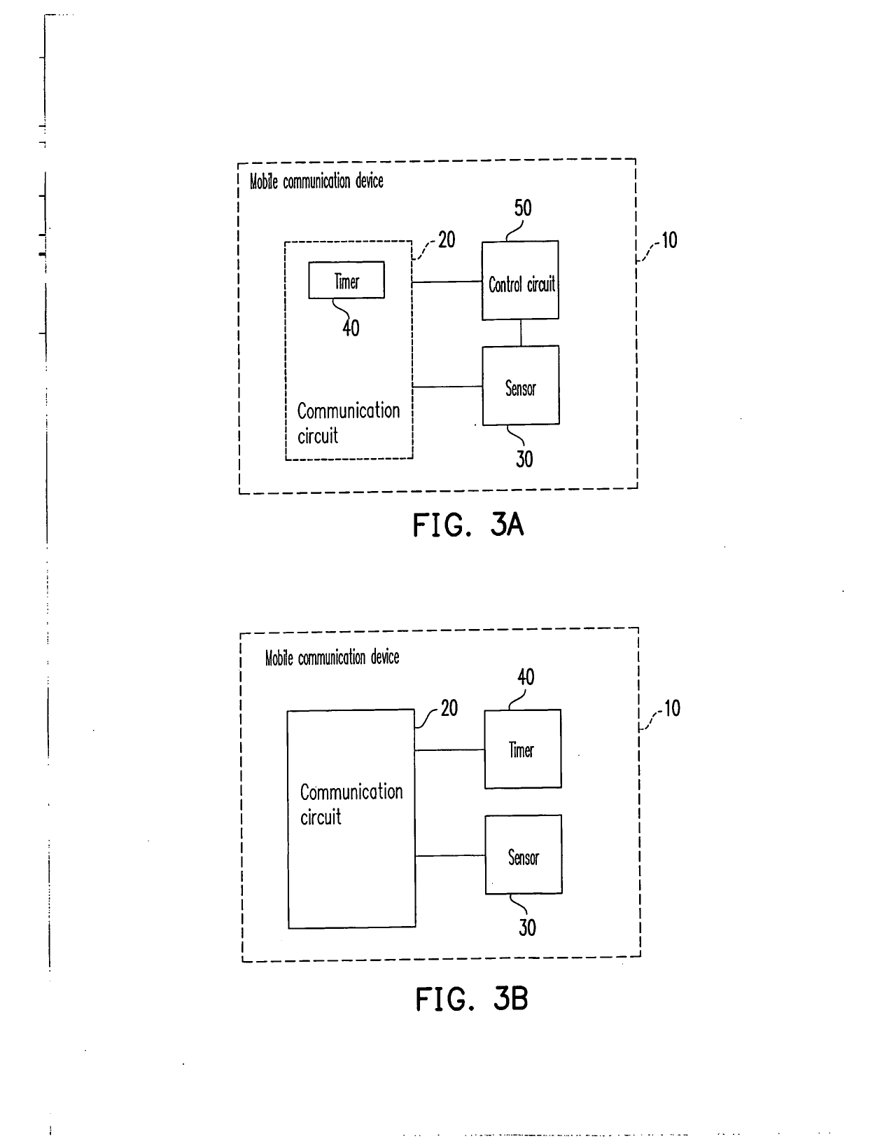

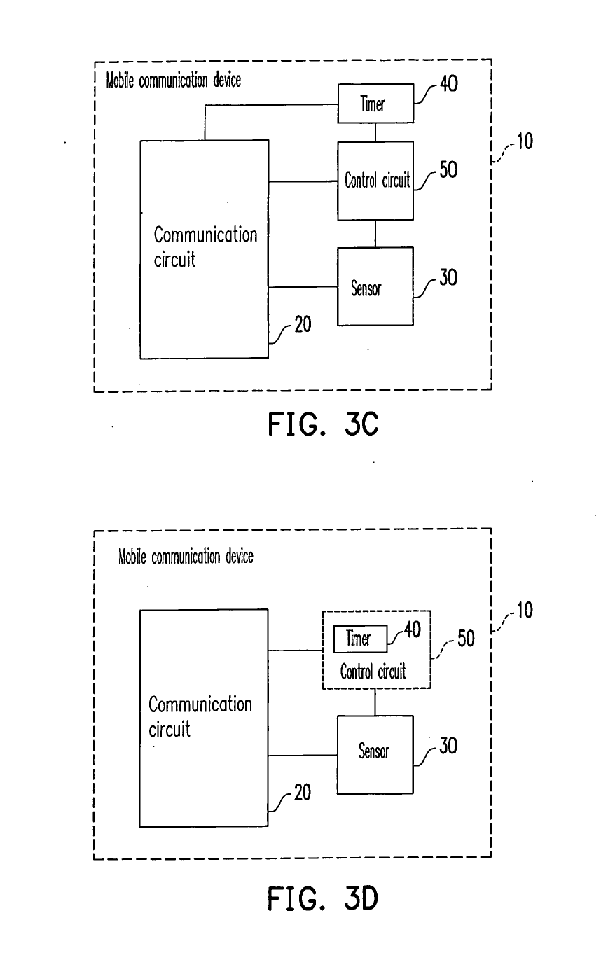

FIG. 3A˜FIG. 3D are structural diagrams showing another mobile communication device according to the preferred embodiment of the invention. Persons having ordinary skill in the art can, based on their requirements, modify the structural diagram of the mobile communication device shown in FIG. 1 according to the spirit of the invention and the disclosure in the above embodiments. For example, a control circuit 50 is further provided, and the control circuit 50 can be, for example, a control chip and determines the mobile communication device 10 to enter the normal mode or the power saving mode (in FIG. 3A) according to the moving state detected by the sensor 30 of the mobile communication device 10. For example, the timer 40 is provided outside the communication circuit 20, that is, the communication circuit 20 utilizes the timer 40 inside the mobile communication device 10 (as shown in FIG. 3B and FIG. 3C) to measure the first, second and third predetermined time. The timer 40 even can be provided at the interior of the control circuit 50 (as shown in FIG. 3D) to form a module to enhance the versatility, so that mass production can reduce the cost.

Although the present invention has been described in considerable detail with reference to certain preferred embodiments thereof, the disclosure is not for limiting the scope of the invention.

Persons having ordinary skill in the art may make various modifications and changes without departing from the scope and spirit of the invention. Therefore, the scope of the appended claims should not be limited to the description of the preferred embodiments described above.

What is claimed is:

1. A power saving method of a mobile communication device, the method comprising steps of:
entering a normal mode;
starting a timing start function of the mobile communication device to make the mobile communication device determine whether to switch to a selected cell every a first predetermined time when the mobile communication device enters the normal mode; and
entering a power saving mode and closing the timing start function according to the moving state of the mobile communication device.

2. The power saving method of the mobile communication device according to claim 1, wherein the step of entering the power saving mode according to the moving state of the mobile communication device is done when the mobile communication device is not moved for a second predetermined time.

3. The power saving method of the mobile communication device according to claim 1 further comprising the step of:
entering the normal mode if the mobile communication device is moved under the power saving mode.

4. The power saving method of the mobile communication device according to claim 1 further comprising the step of:
returning to the normal mode after the mobile communication has entered the power saving mode for a third predetermined time.

5. A mobile communication device comprising:
a sensor for detecting a moving state of the mobile communication device; and
a communication circuit coupled to the sensor, wherein a timing start function is started when a normal mode is entered, and the timing start function is capable of making the communication circuit determine whether to switch to a selected cell every a first predetermined time according to signal intensity of a plurality of cells, and the communication circuit is capable of entering a power saving mode according to the moving state and closing the timing start function.

6. The mobile communication device according to claim 5, wherein under the normal mode, the communication circuit is capable of entering the power saving mode according to the moving state when the moving state is indicative of that the mobile communication device is not moved for a second predetermined time.

7. The mobile communication device according to claim 5, wherein if the mobile communication device is moved under the power saving mode, the communication circuit enters the normal mode.

8. The mobile communication device according to claim 5, wherein the communication circuit returns to the normal mode after the communication circuit has entered the power saving mode for a third predetermined time.

9. The mobile communication device according to claim 5 further comprising a timer for starting the communication circuit every the first predetermined time under the normal mode to determine whether to switch to a cell according to the signal intensity of cells, wherein the communication circuit starts or closes the timing start function via starting, closing or setting the timer.

10. The mobile communication device according to claim 9, wherein the timer is located at the interior of the communication circuit.

11. The mobile communication device according to claim 5, wherein the sensor comprises a motion sensor.

12. The mobile communication device according to claim 5, wherein the sensor comprises a geomagnetic sensor.

13. A mobile communication device comprising:
a communication circuit for performing the communication function of the mobile communication device;
a sensor which is coupled to the communication circuit and is used for detecting a moving state of the mobile communication device; and
a control circuit coupled to the communication circuit and the sensor, wherein a timing start function is started when a normal mode is entered, and the timing start function is capable of making the communication circuit determine whether to switch to a selected cell every a first predetermined time according to signal intensity of a plurality of cells, and the control circuit is capable of entering a power saving mode according to the moving state and closing the timing start function.

14. The mobile communication device according to claim 13, wherein under the normal mode, the communication circuit is capable of entering the power saving mode according to the moving state when the moving state is indicative of that the mobile communication device is not moved for a second predetermined time.

15. The mobile communication device according to claim 13, wherein if the mobile communication device is moved under the power saving mode, the control circuit enters the normal mode.

16. The mobile communication device according to claim 13, wherein the control circuit returns to the normal mode after the control circuit has entered the power saving mode for a third predetermined time.

17. The mobile communication device according to claim 13 further comprising a timer, wherein the timer starts the communication circuit every the first predetermined time under the normal mode to determine whether to switch to a cell according to the signal intensity of cells, and the control circuit starts or closes the timing start function via starting, closing or setting the timer.

18. The mobile communication device according to claim 13, wherein the communication circuit is a communication chip.

19. The mobile communication device according to claim 13, wherein the control circuit is a control chip.

20. The mobile communication device according to claim 13, wherein the sensor comprises a geomagnetic sensor.
